(19) United States
(12) Patent Application Publication
(10) Pub. No.: US 2024/0237103 A9
(43) Pub. Date: Jul. 11, 2024

(54) DISTRIBUTED ACCESS POINT MULTI-LINK DEVICE

(71) Applicant: NXP USA, INC., Austin, TX (US)

(72) Inventors: Liwen CHU, San Ramon, CA (US); Rui CAO, Sunnyvale, CA (US); Kiseon Ryu, San Diego, CA (US); Hongyuan ZHANG, Fremont, CA (US)

(21) Appl. No.: 18/491,451

(22) Filed: Oct. 20, 2023

Related U.S. Application Data
(60) Provisional application No. 63/380,252, filed on Oct. 20, 2022.
(60) Provisional application No. 63/383,047, filed on Nov. 9, 2022.
(60) Provisional application No. 63/383,044, filed on Nov. 9, 2022.

(51) Int. Cl. H04W 76/15; H04W 8/02

(52) U.S. Cl. CPC H04W 76/15; H04W 8/02

(57) ABSTRACT

Roaming for an ultra-high reliability (UHR) non-access point (non-AP) device with a distributed access point (AP) multi-link device (MLD), wherein the distributed AP MLD includes a plurality of AP MLDs in different devices at different locations having one medium access control (MAC) service access point (SAP), includes: receiving, by the non-AP device, an announcement from the distributed AP MLD configured to indicate that the distributed AP MLD is a distributed AP MLD with the plurality of AP MLDs in different devices wherein the non-AP device is configured to roam among the plurality of AP MLDs in different devices; associating, by the non-AP device, with a first AP MLD of the plurality of AP MLDs in different devices; and roaming, by the non-AP device, to a second AP MLD of the plurality of AP MLDs in different devices without a reassociation.

### CROSS-REFERENCE TO RELATED APPLICATIONS

This application claims the benefit of U.S. Provisional Patent Application No. 63/380,252, filed Oct. 20, 2022, U.S. Provisional Patent Application No. 63/383,047, filed Nov. 9, 2022, and U.S. Provisional Patent Application No. 63/383,044, filed Nov. 9, 2022, the contents of which are incorporated for all purposes by reference herein in its entirety.

### FIELD OF THE DISCLOSURE

Various exemplary embodiments disclosed herein relate to distributed access point (AP) multi-link device (MLD).

### BACKGROUND

In UHR, the use of millimeter (mm) wave bands have been proposed. Because the coverage range of the mm wave bands is less than other bands, the use of AP MLD with the distributed APs may be especially used for the mm wave bands. The distributed mm wave APs affiliated with an AP MLD can cover a large area. As a result, the chance of transitioning from one AP MLD to another AP MLD is less. When a non-AP MLD with mm wave links moves among the devices, the throughput of the non-AP MLD can be guaranteed.

### SUMMARY

A summary of various exemplary embodiments is presented below.

Various embodiments relate to a method of roaming for an ultra-high reliability (UHR) non-access point (non-AP) device with a distributed access point (AP) multi-link device (MLD), wherein the distributed AP MLD includes a plurality of AP MLDs in different devices at different locations having one medium access control (MAC) service access point (SAP), including: receiving, by the non-AP device, an announcement from the distributed AP MLD configured to indicate that the distributed AP MLD is a distributed AP MLD with the plurality of AP MLDs in different devices wherein the non-AP device is configured to roam among the plurality of AP MLDs in different devices; associating, by the non-AP device, with a first AP MLD of the plurality of AP MLDs in different devices; and roaming, by the non-AP device, to a second AP MLD of the plurality of AP MLDs in different devices without a reassociation.

Various embodiments are described, wherein the roaming by the non-AP device is without a further key negotiation.

Various embodiments are described, further including: negotiating a pairwise transient key (PTK) between the first AP MLD and the non-AP device, wherein the PTK is used between the second AP MLD and the non-AP device when the non-AP device roams to the second AP MLD.

Various embodiments are described, wherein a medium access control (MAC) service access point (SAP) is used to calculate the PTK.

Various embodiments are described, including: receiving a unicast data from the distributed MLD AP, wherein a medium access control (MAC) service access point (SAP) replaces a receiver address (RA),transmitter address (TA), or basic service set identifier (BSSID) of a MAC header of a unicast data or management frame for encryption/decryption of the unicast data or management frame if the RA, TA, or BSSID in the MAC header is address of one of the plurality of AP MLDs in different devices.

Various embodiments are described, wherein the first AP MLD is a reporting AP MLD, and the received announcement announces distributed AP MLD level information, reporting AP MLD level information, and information regarding an AP associated with the reporting AP MLD.

Various embodiments are described, wherein the second AP MLD is a reported AP MLD, and the received announcement announces reported AP MLD level information.

Various embodiments are described, wherein the received announcement announces APs associated with the reported AP MLD.

Various embodiments are described, wherein the reporting AP MLD determines whether to announce the information of the reported AP MLD and the information regarding APs associated with the reporting AP MLD.

Various embodiments are described, wherein the received announcement includes the information of the reported AP MLD when the reporting AP MLD determines to announce the information of the reported AP MLD.

Various embodiments are described, wherein the received announcement includes the information regarding the APs associated with the reporting AP MLD when the reporting AP MLD determines to announce the information regarding APs associated with the reporting AP MLD.

Various embodiments are described, wherein associating, by the non-AP device, with a first AP MLD includes indicating by the non-AP device which of the plurality of AP MLDs in different devices it would like to exchange frames with and which of the plurality of AP MLDs the non-AP device would like to roam to.

Various embodiments are described, further including: sending a request to the first AP MLD requesting information regarding the distributed AP MLD; and receiving information from the first AP MLD with information regarding the distributed AP MLD.

Various embodiments are described, wherein sending the request and receiving the information occur before the associating.

Various embodiments are described, wherein sending the request and receiving the information occur before the roaming.

Various embodiments are described, further including: carrying out a key handshake to authenticate all link addresses of a reporting AP MLD, reported AP MLDs, a AP MLD medium access control (MAC) service access point (SAP) addresses, and a distributed AP MLD MAC SAP address; authenticating all link addresses of the non-AP and a MAC SAP address of the non-AP; and calculating a pairwise transient key (PTK) based on MAC SAP address of the distributed AP MLD and a MAC SAP address of the non-AP.

Various embodiments are described, further including: carrying out a key handshake to authenticate all link addresses of a reporting AP MLD, the reported AP MLDs that the association includes, a AP MLD medium access control (MAC) service access point (SAP) addresses, and a distributed AP MLD MAC SAP address; authenticating all link addresses of the non-AP and a MAC SAP address of the non-AP; and calculating a pairwise transient key (PTK) based on MAC SAP address of the distributed AP MLD and a MAC SAP address of the non-AP.

Various embodiments are described, further including: carrying out a key handshake to authenticate all link addresses of a reporting AP MLD, a AP MLD medium access control (MAC) service access point (SAP) addresses, and a distributed AP MLD MAC SAP address; authenticating all link addresses of the non-AP and a MAC SAP address of the non-AP; and calculating a pairwise transient key (PTK) based on MAC SAP address of the distributed AP MLD and a MAC SAP address of the non-AP.

Various embodiments are described, wherein the non-AP acquires a group transient key (GTK), integrity group transient key (IGTK), beacon integrity group transient key (BIGTK) of a roamed link with the second AP MLD.

Various embodiments are described, wherein the distributed AP MLD maintains sequence number spaces of unicast quality of service (QoS) data frames.

Various embodiments are described, wherein the distributed AP MLD performs duplication detection of unicast QoS data frames.

Various embodiments are described, wherein when roaming from the first AP MLD to the second AP MLD, sequence number space information is transferred from the first AP MLD to the second AP MLD.

Various embodiments are described, wherein a sequence number being used for next frame and receiver cache information are transferred from the first AP MLD to the second AP MLD.

Various embodiments are described, wherein the Tx Window (WinStartO, WinSizeO), scoreboard context information, and reorder buffer information (WinStartR, WinSizeR, WinStartB, WinSizeB) are transferred from the first AP MLD to the second AP MLD.

Further various embodiments relate to a non-access point (non-AP) device with a distributed access point (AP) multi-link device (MLD), wherein the distributed AP MLD includes a plurality of AP MLDs in different devices at different locations having one medium access control (MAC) service access point (SAP), including: a receive configured to receive an announcement from a distributed AP MLD, wherein the announcement is configured to indicate that the distributed AP MLD is a distributed AP MLD with a plurality of AP MLDs in different devices at different locations and wherein the non-AP device is configured to roam among the plurality of AP MLDs in different devices; and a processor configured to: associate the non-AP device with a first AP MLD of the plurality of AP MLDs in different devices; and roam to a second AP MLD of the plurality of AP MLDs in different devices without a reassociation.

Various embodiments are described, wherein the roaming by the non-AP device is without a further key negotiation.

Various embodiments are described, wherein associating, the non-AP device with a first AP MLD includes indicating by the non-AP device which of the plurality of AP MLDs in different devices frames are exchanged with and which of the plurality of AP MLDs the non-AP device roams to.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram of an example wireless local area network (WLAN) 10, according to an embodiment.

FIG. 2 illustrates a distributed AP MLD according to an embodiment.

FIG. 3 illustrates the organization of a distributed AP MLD according to an embodiment.

FIG. 4 illustrates a distributed AP MLD1 interacting with a UHR non-AP MLD2 and a EHT non-AP MLD3 according to an embodiment.

FIG. 5 illustrates a first option for the data frame path of a distributed AP MLD according to an embodiment.

FIG. 6 illustrates a second option for the data frame path of a distributed AP MLD according to an embodiment.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of WiFi systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

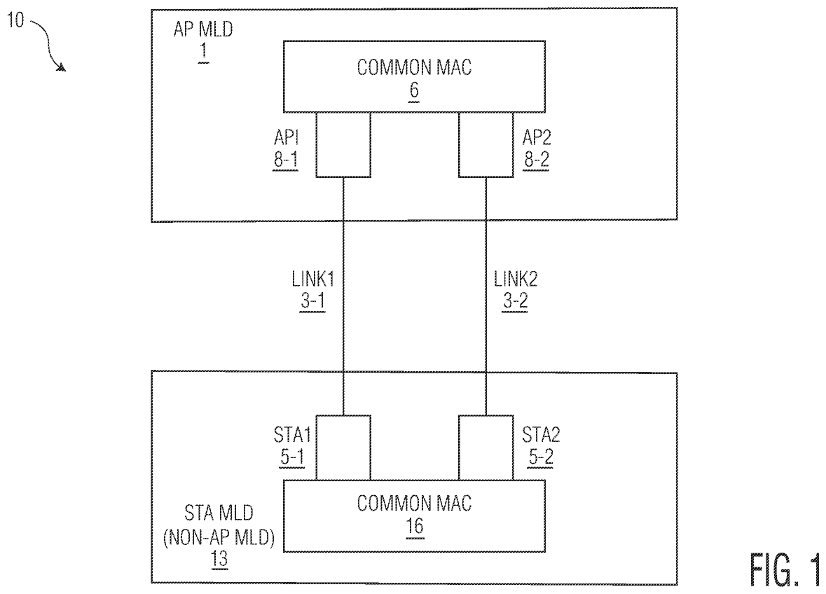

FIG. 1 depicts a multi-link communications system 10 that is used for wireless (e.g., WiFi) communications. In the embodiment depicted in FIG. 1, the multi-link communications system includes one AP multi-link device, which is implemented as AP MLD 1, and one non-AP STA multi-link device, which is implemented as STA MLD (non-AP MLD) 13. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Various iterations of the 802.11 specification are referred to herein. IEEE 802.11ac is referred to as very high throughput (VHT). IEEE 802.11ax is referred to as high efficiency (HE). IEEE 802.11be is referred to as extreme high throughput (EHT). IEEE 802.11bn is referred to as ultra-high reliability (UHR). The terms VHT, HE, EHT, and UHR will be used in the descriptions found herein.

Although the depicted multi-link communications system 10 is shown in FIG. 1 with certain components and described with certain functionality herein, other embodiments of the multi-link communications system may include fewer or more components to implement the same, less, or more functionality. For example, in some embodiments, the multi-link communications system includes a single AP MLD and multiple associated STA MLDs, or multiple AP MLDs and multiple STA MLDs with each STA MLD being associated with an AP MLD. In some embodiments, the legacy STAs (non-HE STAs) associate with one of the APs affiliated with the AP MLD. In some embodiment an AP MLD may have a single affiliated AP. In some embodiment a STA MLD may have a single affiliated STA. In another example, although the multi-link communications system is shown in FIG. 1 as being connected in a certain topology, the network topology of the multi-link communications system is not limited to the topology shown in FIG. 1.

In the embodiment depicted in FIG. 1, the AP MLD 1 includes a common MAC 6 and two APs 8-1, 8-2 in two links. In such an embodiment, the APs may be AP1 8-1 and AP2 8-2. In some embodiments, a common MAC 6 of the AP MLD 1 implements upper layer Media Access Control (MAC) functionalities (e.g., association establishment, reordering of frames, etc.) and a link specific part of the AP MLD 1, i.e., the APs 8-1 and 8-2, implement lower layer MAC functionalities (e.g., backoff, frame transmission, frame reception, etc.), PHY layer functionalities, radios. The APs 8-1 and 8-2 may be implemented in hardware (e.g., circuits), software, firmware, or a combination thereof. The APs 8-1 and 8-2 may be fully or partially implemented as an integrated circuit (IC) device. In some embodiments, the APs 8-1 and 8-2 may be wireless APs compatible with at least one WLAN communications protocol (e.g., at least one IEEE 802.11 protocol). For example, the APs 8-1 and 8-2 may be wireless APs compatible with the IEEE 802.11bn protocol.

In some embodiments, an AP MLD (e.g., AP MLD 1) connects to a local area network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiment, an AP (e.g., AP1 8-1 and/or AP2 8-2) includes multiple RF chains. In some embodiments, an AP (e.g., AP1 8-1 and/or AP2 8-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 8-1 or 8-2 of the AP MLD 1 with multiple RF chains may operate in a different BSS operating channel (in a different link). For example, AP1 8-1 may operate in a 320 MHz BSS operating channel at 6 GHz band, and AP2 8-2 may operate in a 160 MHz BSS operating channel at 5 GHz band. Although the AP MLD 1 is shown in FIG. 1 as including two APs, other embodiments of the AP MLD 204 may include more than two APs, or one AP only.

In the embodiment depicted in FIG. 1, the non-AP STA multi-link device, implemented as STA MLD 13, includes a common MAC 16, two non-AP STAs 5-1 and 5-2 in two links. In such an embodiment, the non-AP STAs may be STA1 5-1 and STA2 5-2. The STAs 5-1 and 5-2 may be implemented in hardware (e.g., circuits), software, firmware, or a combination thereof. The STAs 5-1 and 5-2 may be fully or partially implemented as an IC device. In some embodiments, the non-AP STAs 5-1 and 5-2 are part of the STA MLD 13, such that the STA MLD may be a communications device that wirelessly connects to a wireless AP MLD. For example, the STA MLD 13 may be implemented in a laptop, a desktop personal computer (PC), a mobile phone, or other communications device that supports at least one WLAN communications protocol. In some embodiments, the non-AP STA MLD 13 is a communications device compatible with at least one IEEE 802.11 protocol (e.g., an IEEE 802.11bn protocol, an IEEE 802.11be protocol, an IEEE 802.11ax protocol, or an IEEE 802.11ac protocol). In some embodiments, the STA MLD 13 implements a common MAC functionalities 16 and the non-AP STAs 5-1 and 5-2 implement a lower layer MAC data functionalities, PHY functionalities.

In some embodiments, the AP MLD 1 and/or the STA MLD 13 may identify which communication links support multi-link operation during a multi-link operation setup phase and/or exchanges information regarding multi-link capabilities during the multi-link operation setup phase. In some embodiments, each of the non-AP STAs 5-1 and 5-2 of the STA MLD 13 in different link may operate in a different frequency band. For example, the non-AP STA1 5-1 in one link may operate in the 2.4 GHz frequency band and the non-AP STA2 5-2 in another link may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 1, the STA MLD 13 communicates with the AP MLD 1 via two communication links, e.g., link 1 3-1 and link 2 3-2. For example, each of the non-AP STAs 3-1 or 3-2 communicates with an AP 8-1 or 8-2 via corresponding communication links 3-1 or 3-2. In an embodiment, a communication link (e.g., link 1 3-1 or link 2 3-2) may include a BSS operating channel established by an AP (e.g., AP1 8-1 or AP2 8-2) that features multiple 20 MHz channels used to transmit frames (e.g., Beacon frames, management frames, etc.) being carried in Physical Layer Convergence Protocol (PLCP) Protocol Data Units (PPDUs) between a first wireless device (e.g., an AP, an AP MLD, an STA, or an STA MLD) and a second wireless device (e.g., an AP, an AP MLD, an STA, or an STA MLD). In some embodiments, a 20 MHz channel may be a punctured 20 MHz channel or an unpunctured 20 MHz channel. Although the STA MLD 13 is shown in FIG. 1 as including two non-AP STAs, other embodiments of the STA MLD 13 may include one non-AP STA or more than two non-AP STAs. In addition, although the AP MLD 1 communicates (e.g., wirelessly communicates) with the STA MLD 13 via multiple links 3-1 and 3-2, in other embodiments, the AP MLD 1 may communicate (e.g., wirelessly communicate) with the STA MLD 13 via more than two communication links or less than two communication links.

As described above a multi-link AP MLD has one or multiple links where each link has one AP affiliated with the AP MLD. This may be accomplished by having the different radios for the different affiliated APs.

A multi-link STA MLD has one or multiple links where each link has one STA affiliated with the STA MLD. One way to implement the multi-link STA MLD is using two or more radios, where each radio is associated with a specific link. For example, an multi-link multi-radio (MLMR) non-AP MLD may be used. The MLMR non-AP MLD uses multiple full functional radios to monitor the medium in multiple links. Another way to implement the multi-link STA MLD is using a single radio in two different bands. Each band may be associated with a specific link. In this case only one link is available at a time. In yet another implementation, an enhanced single-radio (ESR) STA MLD may be used that operates in an enhanced multi-link single radio (eMLSR) mode. The ESR STA MLD uses two radios in different bands to implement the MLD. For example, one radio may be a lower cost radio with lesser capabilities and the other radio may be a fully functional radio supporting the latest protocols. The ESR STA MLD may dynamically switch its working link while it can only transmit or receive through one link at any time. The ESR STA MLD may monitor two links simultaneously, for example, detecting medium idle/busy status of each link, or receiving a PPDU on each link. Each radio may have its own backoff time, and when the backoff counter for one of the radios becomes zero that radio and link may be used for transmission. For example, if an AP wants to use the fully functional radio, it may send a control frame that is long enough for the ESR STA MLD to switch from the lesser capable radio to the fully functional radio that may then transmit data to the AP.

An AP MLD in multi-link operation may remove its links through MLD reconfiguration. multi-link (ML) reconfiguration broadly refers to a set of post-association procedures to make changes to links between APs and non-AP STAs affiliated with two MLDs including adding or removing links, and without disassociation. This may be accomplished using the reconfiguration multi-link element in a beacon frame. As a result, the AP MLD may have only one link after link removal. Also, a mobile AP MLD may only have one link because often these devices are power constrained, and the use of only a single link saves power.

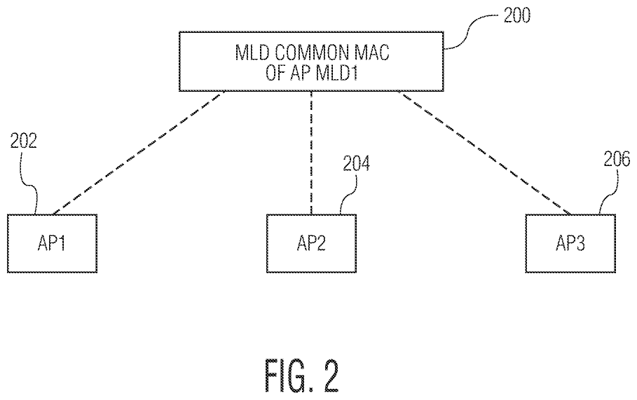

Distributed AP MLDs have been proposed. FIG. 2 illustrates a AP MLD with the distributed APs according to an embodiment. The AP MLD with the distributed APs 200 includes three APs, i.e., AP1 202, AP2 204, and AP3 206. AP1 202, AP2 204, and AP3 206 may be separate devices that are located in different physical locations. The AP MLD with the distributed APs 200 has a common MAC address that is used for all of AP1 202, AP2 204, and AP3 206. This provides the benefit that as a non-AP MLD roams it can easily move from one AP to another of the distributed AP MLD without the need for reassociation.

In UHR, the use of millimeter (mm) wave bands have been proposed. Because the coverage range of the mm wave bands is less than other bands, the use of AP MLD with the distributed APs may be especially used for the mm wave bands. The distributed mm wave APs affiliated with an AP MLD can cover a large area. As a result, the chance of transitioning from one AP MLD to another AP MLD is less. When a non-AP MLD with mm wave links moves among the devices, the throughput of the non-AP MLD can be guaranteed.

Hot-standby AP MLD method has been proposed for faster roaming where a STA MLD can have two associated AP MLDs during the roaming stage. One of the two associated AP MLDs is the serving AP MLD and another one is the hot-standby AP MLD. The hot-standby AP MLD is the new serving AP MLD that the STA MLD would like to roam to in the near future. When a non-AP MLD does frame exchanges with its serving AP MLD, the non-AP MLD also does association and key establishment with the hot-standby AP MLD. This allows for the non-AP MLD to easily move from the serving AP MLD to the hot-standby AP MLD when roaming.

Potential issues with the use of AP MLD with the distributed APs and hot-standby AP MLDs exist. The following issues with AP MLD with the distributed APs should be addressed. An EHT non-AP MLD cannot figure out whether the APs affiliated with an AP MLD are an EHT AP MLD or not and may be associated with the APs that are in different locations. The real time information exchanges between the APs to support NSTR/eMLSR operation of STA MLD in different location is required. The reordering of data frames at a common location is also needed. Such operations are difficult to implement. The traffic indication map (TIM) element carries the buffered information of all the associated non-AP MLDs whose traffic identifiers (TID) are mapped to power save non-AP STAs affiliated with non-AP MLDs. The TIM may become long when the AP MLD with the distributed APs includes some many distributed APs. The maximal links of an AP MLD and non-AP MLD are no more than 15 links. Another restriction is that maximal number of STA MPDs that are associated with a AP MLD with the distributed APs is 2006.

The following issues with hot-standby AP MLDs should be addressed. The multi-link association and key negotiation are required for the serving AP MLD and each hot-standby AP MLD.

The following assumptions are used concerning distributed APs. In some deployments, some distributed APs affiliated with the same distributed AP MLD in the same band may have the same BSS operating channels as BSS operating channels. If an EHT non-AP MLD finds such information of the distributed AP, it will see two of the distributed MLD APs of the distributed AP MLD with the same operating channel. This is not allowed for EHT implementations and it will assume that the distributed AP MLD does not follow the 802.11 specification and does not establish the association with the distributed AP MLD.

Further, the various links used by the distributed AP MLD will be STR links that are spread across the AP MLDs. A non-AP MLD may do the association with the distributed AP MLD through the APs in the different locations. As a result these APs affiliated with the distributed AP MLD may share Tx buffer control and reorder buffer control in the common location because a non-AP MD may transmit the QoS Data frames form the same TID to the APs in different locations. Such a requirement is difficult to implement. Another observation is that a STA MLD associated with the distributed AP MLD through the APs in different locations may be a NSTR STA MLD, and the APs in different location needs to do the PPDU start time alignment and the ending time alignment which is difficult to do. Similarly it is difficult for a distributed AP MLD through the APs in different locations to do the frame exchanges with an EMLSR/EMLMR STA MLD.

When announcing an AP MLD with distributed APs through (MLD MAC address in) basic multi-link element and reduced neighbor reports (RNR), an EHT non-AP MLD treats it as an AP MLD. This leads to the following potential issues. Any link pair of all the links is a STR link pair. The allowed number of APs in an AP MLD cannot be more than 15 APs. There may also be problems reordering packets sent across different link. The same operating channel is not allowed for the distributed APs within the AP MLD. It is difficult for an EHT non-AP MLD to figure out the allowed links for it to do the multi-link association.

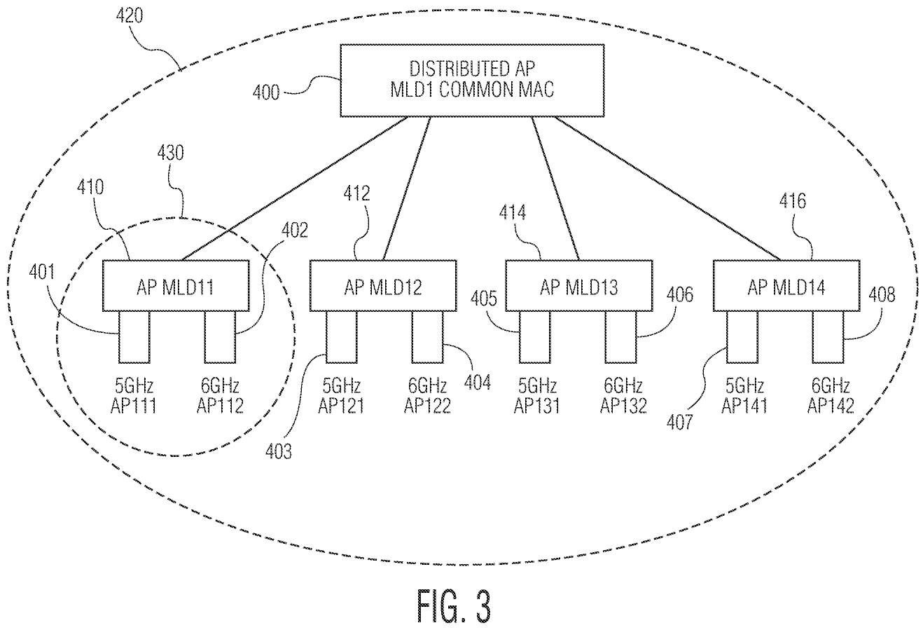

In one embodiment, a distributed AP MLD includes multiple affiliated AP MLDs that are in different location. In one embodiment, in order to differentiate between each AP MLD in a distributed AP MLD, each AP MLD has a unique ID to identify the AP LMD in the distributed AP MLD. In one embodiment, the distributed AP MLD has one MAC service access point (SAP) address, i.e., the distributed AP MLD MAC SAP address. FIG. 3 illustrates the organization of a distributed AP MLD or roaming AP MLD according to an embodiment. The distributed AP MLD1 400 includes AP MLD11 410, AP MLD12 412, AP MLD13 414, and AP MLD14 416. It is noted that the distributed AP MLD1 400 may include more or fewer AP MLDs. The distributed AP MLD1 400 has a single MAC SAP address that is used for all AP MLDs that are affiliated with the distributed AP MLD1 400 to connect to the distribution system (DS), i.e., AP MLD11 410, AP MLD12 412, AP MLD13 414, and AP MLD14 416. Further, AP MLD11 410, AP MLD12 412, AP MLD13 414, and AP MLD14 416 each have a unique ID (e.g. being named as AP MLD ID) within the distributed AP MLD1 400 using an ID space as discussed above. For example, AP MLD11 410, AP MLD12 412, AP MLD13 414, and AP MLD14 416 may have IDs of 1, 2, 3, and 4 respectively. Each of the AP MLDs that are part of the distributed AP MLD1 400 may include a 5 GHz AP and a 6 GHz AP. AP MLD11 410 includes 5 Ghz AP111 401 and 6 GHz AP112 402; AP MLD12 412 includes 5 Ghz AP121 403 and 6 GHz AP122 404; AP MLD13 414 includes 5 Ghz AP131 405 and 6 GHz AP132 406; and AP MLD14 416 includes 5 Ghz AP141 407 and 5 Ghz AP141 408. In one embodiment, each AP MLD affiliated with a distributed AP MLD has a unique ID in the distributed AP MLD. In one embodiment, the AP MLD ID is used to identify the resource within the distributed AP MLD. Assume the link used by AP111 401 has link ID 1 in AP MLD 11 410, and the link used by AP112 402 has link ID 2 in AP MLD11 410. The link ID of the link used by AP111 401 in AP MLD11 410 in distributed AP MLD1 400 is AP MLD ID 1+Link ID 1. Assume a STA MLD be associated with AP MLD12 412 has AID 5. The AID of the STA MLD in distributed AP MLD1 400 is AP MLD ID 2+AID 1.

If 5 Ghz AP121 403 is the reporting AP, then the reporting AP MLD is AP MLD12 412, and AP MLD11 410, AP MLD13 414, and AP MLD14 416 are the reported AP MLDs, i.e., when 5 Ghz AP121 403 in AP MLD11 410 sends a beacon frame, the beacon frame may include information regarding the reported AP MLDs, e.g., AP MLD11 410, AP MLD13 414, and AP MLD14 416.

In one embodiment, the distributed AP MLD is visible to UHR non-AP MLDs (same as STA MLDs herein) if the UHR non-AP MLDs support the smooth roaming operation within a distributed AP MLD, and the distributed AP MLD is not visible to EHT non-AP MLDs (same as STA MLDs herein). In one embodiment, the distributed AP MLD is visible to UHR non-AP MLDs (same as STA MLDs herein) that support the smooth roaming operation within a distributed AP MLD if not all UHR non-AP MLDs support the smooth roaming operation within the distributed AP MLD, and the distributed AP MLD is not visible to EHT non-AP MLDs and UHR non-AP MLDs that support the smooth roaming operation within a distributed AP MLD. As an example, in FIG. 3, area 420 denotes AP MLDs that are visible to UHR non-AP MLDs. Area 430 denotes AP MLDs that are visible to EHT non-AP MLDs. With such arrangement, an EHT non-AP MLD cannot associate with a distributed AP MLD with affiliated APs in different locations. An UHR non-AP MLD can associate with a distributed AP MLD.

How the distributed AP MLD1 400 will be announced using beacons and probe response will now be described. Each AP affiliated with a distributed AP MLD through its affiliated AP MLD announces its affiliated AP MLD and its affiliated distributed AP MLD. For example, in the case of 6 GHz AP132 406, it would announce that AP MLD13 414 is its associated AP MLD and that distributed AP MLD1 400 is its associated distributed AP MLD. AP132 406 announces its associated distributed AP MLD1 400 in a way that an EHT non-AP MLD does not understand the announcement of the affiliated distributed AP MLD. Each AP affiliated with a distributed AP MLD announces the reporting AP MLD and reported AP MLD(s) in its beacon frame or probe response frame. This may be done using an (enhanced) ML element for reporting AP MLD, an enhanced RNR element for reported AP MLDs, or a new defined element can be used. Three options for announcing distributed MLD information will be described.

In a first option, each AP affiliated with a distributed AP MLD announces the distributed AP MLD level information, the reporting AP MLD level information, the AP affiliated with the reporting AP MLD, the reported AP MLD level information (e.g., MAC SAP address, reported MLD ID within the distributed AP MLD), and the APs affiliated with the reported AP MLDs in its beacon frame or probe response frame. In this option an enhanced RNR element or a newly defined element can be used to announce the information.

In a second option, each AP affiliated with a distributed AP MLD announces the distributed AP MLD level information, the reporting AP MLD level information, the AP affiliated with the reporting AP MLD, the reported AP MLD information (e.g., MAC SAP address, reported MLD ID within the distributed AP MLD) in its beacon frame or probe response frame. The APs affiliated with the reported AP MLDs are not announced in the beacon from or the probe response frame.

In a third option, each AP affiliated with a distributed AP MLD announces the distributed AP MLD level information, the reporting AP MLD level information, the AP affiliated with the reporting AP MLD, optionally information for one or more reported AP MLDs, and optionally the APs affiliated with one or more reported AP MLDs in its beacon frame or probe response frame.

In a fourth option, each AP affiliated with a distributed AP MLD announces the distributed AP MLD level information, the reporting AP MLD level information, the AP affiliated with the reporting AP MLD, in its beacon frame or probe response frame.

One example is that the other reporting AP MLD includes one-hop reported AP MLDs (i.e., AP MLDs that are close to the reporting AP MLD) and the affiliated APs are reported. One example of a one-hop definition is that the reported AP MLD and reporting MLD do not need to have at least the same operating channel. Another example of one-hop definition is that the reported AP MLD and reporting MLD need to have at least one same operating channel.

For example, if 5 Ghz AP111 401 sends a beacon frame, it would announce information for distributed AP MLD1 400, AP MLD11 410, and 6 GHz AP112 402 which is the other AP in AP MLD11 410. In option 1, the AP MLD11 410 would also announce information for the reported APs, i.e., AP MLD12 412, AP MLD13 414, and AP MLD14 416 as well as information regarding their associated APs, i.e., 5 Ghz AP121 403, 6 GHz AP122 404, 5 Ghz AP131 405, 6 GHz AP132 406, 5 Ghz AP141 407, and 5 Ghz AP141 408. In option 2, the AP MLD11 410 would also announce information for the reported APs, i.e., AP MLD12 412, AP MLD13 414, and AP MLD14 416. But the APs affiliated with the reported AP MLDs are not announced. In a third option, the AP MLD11 410 may optionally announce the information of one or more of the reported AP MLDs. Further, the AP MLD11 410 may optionally announce the APs affiliated with one or more reported AP MLDs.

These beacon announcements help when a non-AP MLD needs to roam between AP MLDs of the distributed AP MLD because the non-AP MLD is already aware of the other AP MLDs in the distributed AP MLD and can easily start communicating with them.

An AP, e.g., 5 Ghz AP111 401 may be the transmitted BSSID AP that has a nontransmitted BSSID AP (say AP811) affiliated with another AP MLD (say AP MLD810 that is not shown in the figure). This AP may be affiliated with another distributed AP MLD (say distributed AP MLD800 that is not shown in the figure) through its affiliated AP MLD. This leads to a situation where the following are carried out. In the Beacon and Probe Response of AP111 401, the reporting AP (AP811) announces the reporting AP MLD (AP MLD 810) with which the AP11 is affiliated and the reported AP MLD(s) of the distributed AP MLD800. The enhanced ML element, enhanced RNR element, or a new defined element can be used for this reporting.

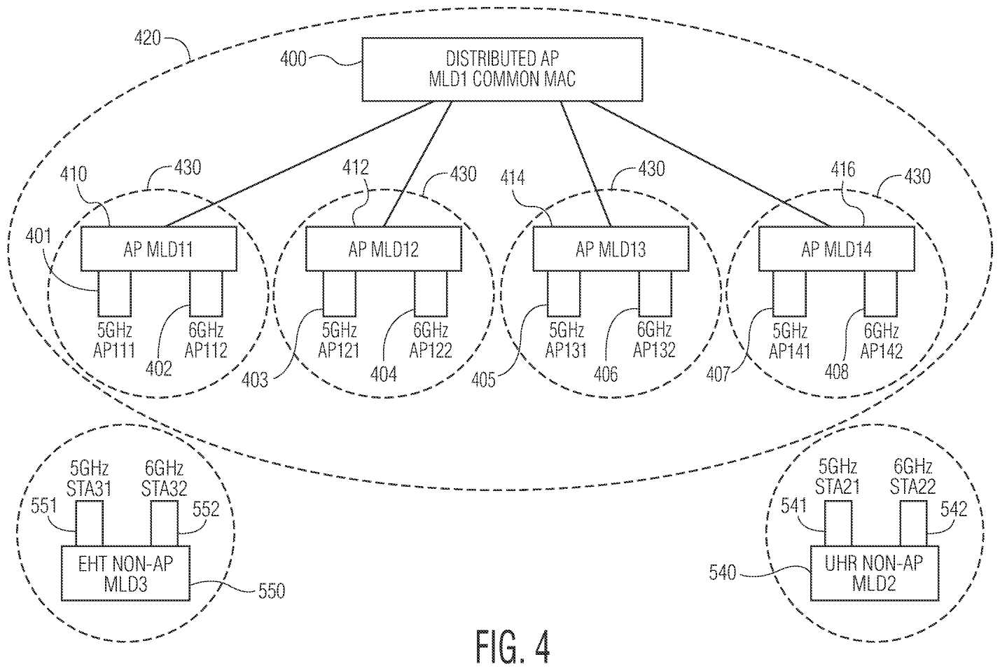

FIG. 4 illustrates a distributed AP MLD1 interacting with a UHR non-AP MLD2 and a EHT non-AP MLD3 according to an embodiment. When the UHR non-AP MLD2 540 becomes associated with the distributed AP MLD1 400, the UHR non-AP MLD2 540 may receive only a portion of the information related to the distributed AP MLD1 400 and its associated AP MLDs and APs. The UHR non-AP MLD2 540 may request the additional information regarding the distributed AP MLD 400 through a ML probe request or a new management frame. A updated ML element (e.g. being named a Distributed ML element) in a ML probe request indicates the request for distributed MLD information, e.g., the reported AP MLD information through the reporting AP MLD. An AP MLD such as AP MLD14 416 may send the information regarding the distributed AP MLD 400 in the ML probe response or a new defined management frame after receiving the soliciting frame to request the distributed AP MLD information. A Distributed multi-link element in ML probe request indicates the request of distributed MLD information, e.g. the reported AP MLD information through reporting AP MLD. Such an information request may be done before the association or before the roaming.

When the UHR non-AP MLD2 540 seeks to associate with the distributed AP MLD1 400 through an AP MLD (e.g. AP MLD14 416) affiliated with the distributed AP MLD1 400 and further through an AP affiliated with the AP MLD14 416 such as 5 Ghz AP141 407, the UHR non-AP MLD2 540 indicates whether it would like to carry out a distributed multi-link association or not when the recipient AP is affiliated with a distributed AP MLD through an AP MLD affiliated with the distributed AP MLD. In a first example method, when the association request/response carries a Distributed ML element, the negotiated association is a multi-link association with a distributed AP MLD. During negotiation of the association with the distributed AP MLD1 400, the UHR non-AP MLD2 540 indicates the AP MLD (serving AP MLD) of the distributed AP MLD that it would like to exchange data/management/control frames of class 3 (class3 is defined in 802.11 related to various states of association procedure) with and which AP MLD(s) that it would like to be able to do roaming with in the future. Another variant is that during negotiation of the association with the distributed AP MLD1 400, the UHR non-AP MLD2 540 only negotiates that it will exchange data/management/control frames of class 3 with AP MLD14 416 of the distributed AP MLD1 400. The AP MLD(s) of the distributed AP MLD used for roaming will then be negotiated/indicated in the future. Because the association is done with the distributed AP MLD1 401, when the UHR non-AP MLD2 540 roams from one serving AP MLD (AP MLD14 416 as an example) affiliated with the distributed AP MLD1 400 to another serving AP MLD (AP MLD13 414 as an example) affiliated with the distributed AP MLD1 400 does not do association.

FIG. 4 also illustrates an EHT non-AP MLD3 550 that interacts with the distributed AP MLD1 400. The EHT non-AP MLD3 550 may include 5 GHz STA31 551 and 6 GHz STA32 552. The EHT non-AP MLD3 550 does not recognize the distributed AP MLD1 400 and only can interact with individual AP MLDs that make up the distributed AP MLD1 400.

Three options for key negotiation under distributed multi-link association will now be described. In a first option 1, the 4-way extensible authentication protocol over LANs (EAPOL) key handshake authenticates all the link addresses of the reporting AP MLD (the serving AP MLD being negotiated), reported AP MLDs and the AP MLD MAC SAP addresses, and the distributed AP MLD MAC SAP address. The 4-way EAPOL key handshake authenticates all the link addresses of the non-AP MLD and the MAC SAP address of the non-AP MLD. The MAC SAP address of the distributed AP MLD and the MAC SAP address of the non-AP MLD are used to calculate the pairwise transient key (PTK).

In a second option, the 4-way EAPOL key handshake authenticates all the link addresses of the reporting AP MLD (the serving AP MLD being negotiated), the reported AP MLDs that the association includes, the AP MLD MAC SAP addresses, and the distributed AP MLD MAC SAP address. The 4-way EAPOL key handshake authenticates all the link addresses of the non-AP MLD and the MAC SAP address of the non-AP MLD. The MAC SAP address of the distributed AP MLD and the MAC SAP address of the non-AP MLD are used to calculate the PTK.

In a third option, the 4-way EAPOL key handshake authenticates all the link addresses of the reporting AP MLD (the serving AP MLD being negotiated), the MAC SAP address of the reporting AP MLD, and the distributed AP MLD MAC SAP address. The 4-way EAPOL key handshake authenticates all the link addresses of the non-AP MLD and the MAC SAP address of the non-AP MLD. The MAC SAP address of the distributed AP MLD and the MAC SAP address of the non-AP MLD are used to calculate the PTK.

How the PTK, group transient key (GTK), integrity group transient key (IGTK), beacon integrity group transient key (BIGTK) are used after roaming will now be described. The PTK is not changed after the roaming within the distributed AP MLD. A roaming non-AP MLD needs to acquire the GTK, IGTK, and BIGTK of the roamed link. The non-AP MLD may acquire the GTK, IGTK, and BIGTK of each roamed link of the new serving AP MLD that is the non-AP MLD's setup link with the new serving AP MLD before or after the roaming. For example, when UHR non-AP MLD2 540 roams from AP MLD14 416 that has setup links related to the AP131 405 and AP132 406 to AP MLD13 414 that has setup links related to AP131 405 and AP132 406, the PTK is the same but the UHR non-AP MLD2 540 needs to obtain the keys GTK, IGTK, and BIGTK from AP131 405 and AP132 406 affiliated with the new serving AP MLD13 414.

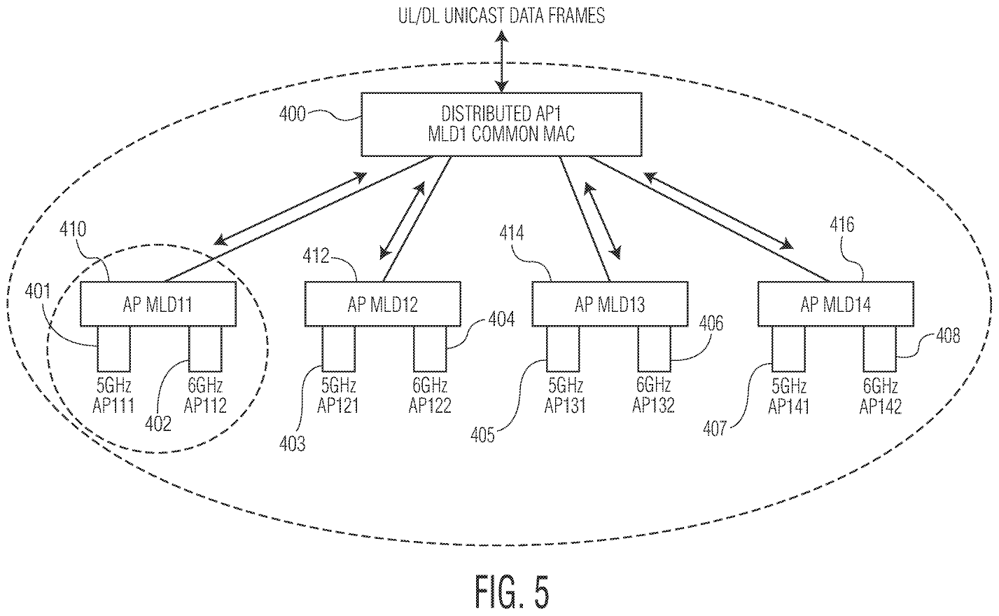

FIG. 5 illustrates a first option for the data frame path of a distributed AP MLD according to an embodiment. For example, sequence numbers may be used to order QoS data frames, but as a non-AP MLD roams from one AP MLD of the distributed AP MLD to another AP MLD, the sequence number may be maintained. Therefore, the sequence number spaces of the unicast QoS data frames are maintained at distributed AP MLD common MAC as illustrated by the arrows in FIG. 5. The duplication detection of unicast QoS data frames is done at the distributed AP MLD1 400. The distributed AP MLD1 400 may have reorder buffers, and the Tx buffer control is maintained at the distributed AP MLD1 400. In another variant, the reorder buffers and the Tx buffer control is maintained at AP MLD level since each non-AP MLD can have only one serving AP MLD at any time.

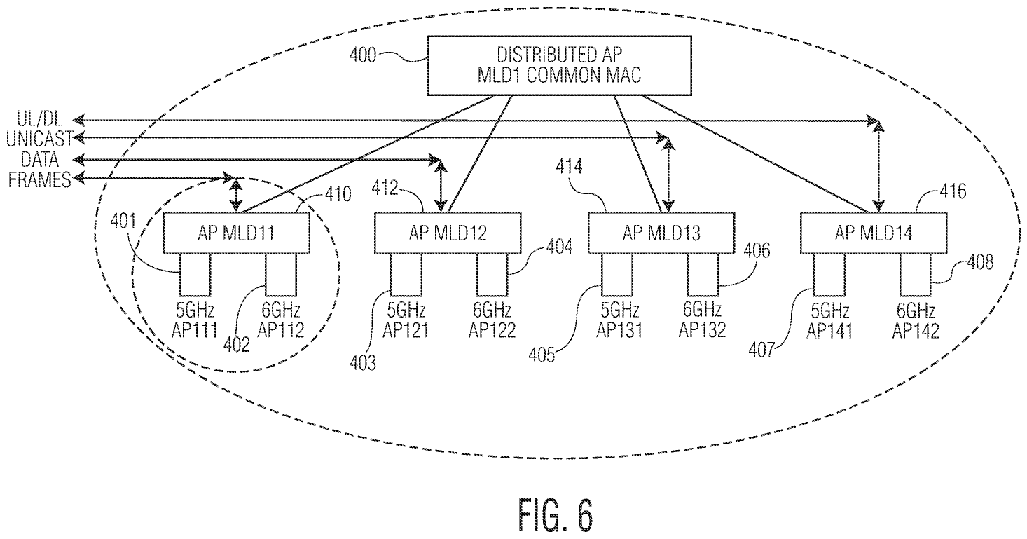

FIG. 6 illustrates a second option for the data frame path of a distributed AP MLD according to an embodiment. The sequence number spaces of unicast QoS Data frames are maintained at distributed AP MLD1 400. When roaming from the current serving AP MLD to the next serving AP MLD, the sequence number space information is transferred from the current serving AP MLD to the next serving AP MLD. The duplication detection of unicast QoS Data frames is done at distributed AP MLD1 400. When roaming from the current serving AP MLD to the next serving AP MLD, the sequence number being used for next frame and receiver cache information are transferred from the current serving AP MLD to the next serving AP MLD. The distributed AP MLD1 400 can have reorder buffers, and the Tx buffer control is maintained at the distributed AP MLD1 400. When roaming from the current serving AP MLD to the next serving AP MLD, the Tx Window (WinStartO, WinSizeO), scoreboard context information (i.e., a list or bitmap for all of the sequence numbers used), reorder buffer information (WinStartR, WinSizeR, WinStartB, WinSizeB) are transferred from the current serving AP MLD to the next serving AP MLD.

Data frame encryption/decryption will now be described. If a non-AP MLD does the distributed multi-link association with a distributed AP MLD, the following are carried out. The unicast data frame between the non-AP MLD and distributed AP MLD is encrypted/decrypted with the AP link address (receiver address (RA),transmitter address (TA), or basic service set identifier (BSSID)) in MAC header replaced by the distributed AP MLD MAC SAP address. The unicast data frame between the non-AP MLD and distributed AP MLD is encrypted/decrypted with the non-AP STA link address (RA or TA) in MAC header replaced by the non-AP MLD MAC SAP address.

If a non-AP MLD does the multi-link association with an AP MLD, the following are carried out. The unicast data frame between the non-AP MLD and AP MLD is encrypted/decrypted with the AP link address (RA,TA, or BSSID) in MAC header replaced by the AP MLD MAC SAP address. The unicast data frame between the non-AP MLD and AP MLD is encrypted/decrypted with the non-AP STA link address (RA or TA) in MAC header replaced by non-AP MLD MAC SAP address.

Management frame encryption/decryption will now be described. In a first option, if a non-AP MLD does the distributed multi-link association with a distributed AP MLD, the following are carried out. The unicast management frame between the non-AP MLD and distributed AP MLD is encrypted/decrypted and the AP link address (RA,TA) in MAC header is replaced with distributed the AP MLD MAC SAP address. The unicast management frame between the non-AP MLD and distributed AP MLD is encrypted/decrypted with the non-AP STA link address (RA,TA) in MAC header replaced by the non-AP MLD MAC SAP address. If a non-AP MLD does the multi-link association with an AP MLD, the following are carried out. The unicast management frame between the non-AP MLD and AP MLD is encrypted/decrypted with the AP link address (RA,TA) in MAC header replaced by the AP MLD MAC SAP address. The unicast management frame between the non-AP MLD and AP MLD is encrypted/decrypted with the non-AP STA link address (RA,TA) in MAC header replaced by the non-AP MLD MAC SAP address.

In a second option, the unicast management frame between the non-AP MLD and distributed AP MLD is encrypted/decrypted with the AP link address (RA,TA) in MAC header. The unicast management frame between the non-AP MLD and distributed AP MLD is encrypted/decrypted with the non-AP STA link address (RA,TA) in MAC header.

The foregoing disclosure provides illustration and description but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Unless otherwise indicated, all numbers expressing parameter values and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by embodiments of the present disclosure. As used herein, “about” may be understood by persons of ordinary skill in the art and can vary to some extent depending upon the context in which it is used. If there are uses of the term which are not clear to persons of ordinary skill in the art, given the context in which it is used, “about” may mean up to plus or minus 10% of the particular term.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method of roaming for a non-access point (non-AP) device with a distributed access point (AP) multi-link device (MLD), wherein the distributed AP MLD includes a plurality of AP MLDs in different devices at different locations having one medium access control (MAC) service access point (SAP), comprising:
receiving, by the non-AP device, an announcement from the distributed AP MLD configured to indicate that the distributed AP MLD is a distributed AP MLD with the plurality of AP MLDs in different devices wherein the non-AP device is configured to roam among the plurality of AP MLDs in different devices;
associating, by the non-AP device, with a first AP MLD of the plurality of AP MLDs in different devices; and
roaming, by the non-AP device, to a second AP MLD of the plurality of AP MLDs in different devices without a reassociation.

2. The method of claim 1, wherein the roaming by the non-AP device is without a further key negotiation.

3. The method of claim 2, further comprising:
negotiating a pairwise transient key (PTK) between the first AP MLD and the non-AP device, wherein the PTK is used between the second AP MLD and the non-AP device when the non-AP device roams to the second AP MLD.

4. The method of claim 3, wherein a medium access control (MAC) service access point (SAP) is used to calculate the PTK.

5. The method of claim 3, comprising:
receiving a unicast data from the distributed MLD AP,
wherein a medium access control (MAC) service access point (SAP) replaces a receiver address (RA),transmitter address (TA), or basic service set identifier (BSSID) of a MAC header of a unicast data or management frame for encryption/decryption of the unicast data or management frame if the RA, TA, or BSSID in the MAC header is address of one of the plurality of AP MLDs in different devices.

6. The method of claim 1, wherein
the first AP MLD is a reporting AP MLD, and
the received announcement announces distributed AP MLD level information, reporting AP MLD level information, and information regarding an AP associated with the reporting AP MLD.

7. The method of claim 6, wherein
the second AP MLD is a reported AP MLD, and
the received announcement announces reported AP MLD level information.

8. The method of claim 7, wherein the received announcement announces APs associated with the reported AP MLD.

9. The method of claim 6, wherein the reporting AP MLD determines whether to announce the information of the reported AP MLD and the information regarding APs associated with the reporting AP MLD.

10. The method of claim 9, wherein the received announcement includes the information of the reported AP MLD when the reporting AP MLD determines to announce the information of the reported AP MLD.

11. The method of claim 9, wherein the received announcement includes the information regarding the APs associated with the reporting AP MLD when the reporting AP MLD determines to announce the information regarding APs associated with the reporting AP MLD.

12. The method of claim 1, wherein associating, by the non-AP device, with a first AP MLD includes indicating by the non-AP device which of the plurality of AP MLDs in different devices frames are exchanged with and which of the plurality of AP MLDs the non-AP device roams to.

13. The method of claim 1, further comprising:
sending a request to the first AP MLD requesting information regarding the distributed AP MLD; and
receiving information from the first AP MLD with information regarding the distributed AP MLD.

14. The method of claim 13, wherein sending the request and receiving the information occur before the associating.

15. The method of claim 13, wherein sending the request and receiving the information occur before the roaming.

16. The method of claim 1, further comprising:
carrying out a key handshake to authenticate all link addresses of a reporting AP MLD, reported AP MLDs, a AP MLD medium access control (MAC) service access point (SAP) addresses, and a distributed AP MLD MAC SAP address;
authenticating all link addresses of the non-AP and a MAC SAP address of the non-AP; and
calculating a pairwise transient key (PTK) based on MAC SAP address of the distributed AP MLD and a MAC SAP address of the non-AP.

17. The method of claim 1, further comprising:
carrying out a key handshake to authenticate all link addresses of a reporting AP MLD, the reported AP MLDs that the association includes, a AP MLD medium access control (MAC) service access point (SAP) addresses, and a distributed AP MLD MAC SAP address;
authenticating all link addresses of the non-AP and a MAC SAP address of the non-AP; and
calculating a pairwise transient key (PTK) based on MAC SAP address of the distributed AP MLD and a MAC SAP address of the non-AP.

18. The method of claim 1, further comprising:
carrying out a key handshake to authenticate all link addresses of a reporting AP MLD, a AP MLD medium access control (MAC) service access point (SAP) addresses, and a distributed AP MLD MAC SAP address;
authenticating all link addresses of the non-AP and a MAC SAP address of the non-AP; and
calculating a pairwise transient key (PTK) based on MAC SAP address of the distributed AP MLD and a MAC SAP address of the non-AP.

19. The method of claim 1, wherein the non-AP acquires a group transient key (GTK), integrity group transient key (IGTK), beacon integrity group transient key (BIGTK) of a roamed link with the second AP MLD.

20. The method of claim 1, wherein the distributed AP MLD maintains sequence number spaces of unicast quality of service (QoS) data frames.

21. The method of claim 20, wherein the distributed AP MLD performs duplication detection of unicast QoS data frames.

22. The method of claim 21, wherein when roaming from the first AP MLD to the second AP MLD, sequence number space information is transferred from the first AP MLD to the second AP MLD.

23. The method of claim 22, wherein a sequence number being used for next frame and receiver cache information are transferred from the first AP MLD to the second AP MLD.

24. The method of claim 23, wherein the Tx Window (WinStartO, WinSizeO), scoreboard context information, and reorder buffer information (WinStartR, WinSizeR, WinStartB, WinSizeB) are transferred from the first AP MLD to the second AP MLD.

25. A non-access point (non-AP) device with a distributed access point (AP) multi-link device (MLD), wherein the distributed AP MLD includes a plurality of AP MLDs in different devices at different locations having one medium access control (MAC) service access point (SAP), comprising:
a receive configured to receive an announcement from a distributed AP MLD, wherein the announcement is configured to indicate that the distributed AP MLD is a distributed AP MLD with a plurality of AP MLDs in different devices at different locations and wherein the non-AP device is configured to roam among the plurality of AP MLDs in different devices; and
a processor configured to:
associate the non-AP device with a first AP MLD of the plurality of AP MLDs in different devices; and
roam to a second AP MLD of the plurality of AP MLDs in different devices without a reassociation.

26. The non-AP device of claim 25, wherein the roaming by the non-AP device is without a further key negotiation.

27. The non-AP device of claim 25, wherein associating, the non-AP device with a first AP MLD includes indicating by the non-AP device which of the plurality of AP MLDs in different devices frames are exchanged with and which of the plurality of AP MLDs the non-AP device roams to.
